(19) United States
(12) Patent Application Publication
(10) Pub. No.: US 2021/0103476 A1
(43) Pub. Date: Apr. 8, 2021

(54) BLOCK STORAGE VIRTUALIZATION MANAGER

(71) Applicant: International Business Machines Corporation, Armonk, NY (US)

(72) Inventor: Long Wen Lan, SHANGHAI (CN)

(21) Appl. No.: 16/595,536

(22) Filed: Oct. 8, 2019

(51) Int. Cl. G06F 9/50; G06F 3/06; G06F 9/455

(52) U.S. Cl. CPC G06F 9/5077; G06F 9/5011; G06F 3/064; G06F 3/0662; G06F 2209/504; G06F 9/45558; G06F 2009/4557; G06F 2009/45583; G06F 3/067

(57) ABSTRACT

Described are techniques for implementing a block storage virtualization (BSV) manager. The techniques including a method comprising associating a Block Storage Virtualization (BSV) manager with a virtual machine (VM) having virtually provisioned block storage resources. The method further comprises aggregating, by the BSV manager, the virtually provisioned block storage resources into a virtual address space having a maximum capacity and an allocated capacity, wherein the allocated capacity is less than the maximum capacity. The method further comprises determining, by the BSV manager, that free space in the allocated capacity is less than a provisioning threshold. The method further comprises, in response to determining that the free space in the allocated capacity is less than the provisioning threshold, procuring, by the BSV manager, a predetermined amount of additional block storage resources for the VM.

### BACKGROUND

The present disclosure relates to data storage, and, more specifically, to management of virtualized block storage.

Data storage can utilize block storage, object storage, or other storage protocols. In block storage, files can be split into evenly sized blocks of data, each with its own address but without any additional information (e.g., no metadata) to provide additional context related to each block of data. Block storage is generally used for storing databases, business applications, supporting virtual machines (VMs), or supporting redundant arrays of independent disks (RAID) arrays. Block storage can provide reliable, low-latency data storage, and can be found in applications such as transactional systems.

In contrast, object storage does not split files into equally sized blocks of data. Instead, object storage stores clumps of data as an object that contains the data itself and metadata related to the data. Object storage is generally used for cloud storage, storage of unstructured data (e.g., documents, images, video, etc.), and Big Data applications. Object storage is generally useful for storing large amounts of data that may be rapidly increasing and that is generally unstructured.

### SUMMARY

Aspects of the present disclosure are directed toward a method comprising associating a Block Storage Virtualization (BSV) manager with a virtual machine (VM) having virtually provisioned block storage resources. The method further comprises aggregating, by the BSV manager, the virtually provisioned block storage resources into a virtual address space having a maximum capacity and an allocated capacity, wherein the allocated capacity is less than the maximum capacity. The method further comprises determining, by the BSV manager, that free space in the allocated capacity is less than a provisioning threshold. The method further comprises, in response to determining that the free space in the allocated capacity is less than the provisioning threshold, procuring, by the BSV manager, a predetermined amount of additional block storage resources for the VM.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computing environment, in accordance with some embodiments of the present disclosure.

FIG. 2 illustrates a block diagram of an example Block Storage Virtualization (BSV) manager, in accordance with some embodiments of the present disclosure.

FIG. 3 illustrates a flowchart of an example method for implementing a BSV manager in a computing environment, in accordance with some embodiments of the present disclosure.

FIG. 4 illustrates a block diagram of an example computer, in accordance with some embodiments of the present disclosure.

FIG. 5 depicts a cloud computing environment, in accordance with some embodiments of the present disclosure.

FIG. 6 depicts abstraction model layers, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward data storage, and, more specifically, to management of virtualized block storage. While not limited to such applications, embodiments of the present disclosure may be better understood in light of the aforementioned context.

In virtual computing environments, users can generally purchase computational resources to be virtually provisioned to them for their use. When purchasing block storage, users pay for a set amount of block storage which they can then use. However, there is often a gap between the amount of storage a user purchases and the amount of block storage that is actually used to store data. In contrast, with object storage, users pay only for the amount of object storage that is actually used. Thus, block storage in cloud environments typically requires more monitoring and adjusting to remain economically efficient.

While additional block storage can be purchased in a cloud computing environment, doing so is complicated. For one, it's difficult to predict an appropriate amount of block storage to purchase to satisfy storage needs, especially in rare or emergency situations. For another, configuring newly added storage can be difficult. When adding new storage, an administrator may need to know (1) when to add the storage, (2) how to purchase the storage, (3) how to attach the newly purchased storage to a target virtual machine (VM), and/or (4) how to configure the Operating System (OS) to utilize the newly purchased storage. For example, when adding another block device to a VM, the OS may consider the newly added block device to be a new disk which needs to be added to an existing file system or have a new file system created on it.

Users currently need to perform operations inside of a VM to correctly add new block storage. This can be complicated and time consuming. Further, in some situations, users need to stop applications executing on a VM in order to remount a file system with newly purchased block storage. Stopping applications degrades service availability.

In light of the aforementioned challenges, aspects of the present disclosure are directed toward a Block Storage Virtualization (BSV) manager configured to aggregate multiple cloud block devices of a VM into one or several space efficient virtual volumes and automate (1) provisioning of additional block storage resources and/or (2) consolidating existing block storage resources by monitoring storage usage without deteriorating application availability. The BSV manager discussed above can thus increase storage efficiency and lower storage costs for end users running workloads in a virtual computing environment utilizing block storage resources.

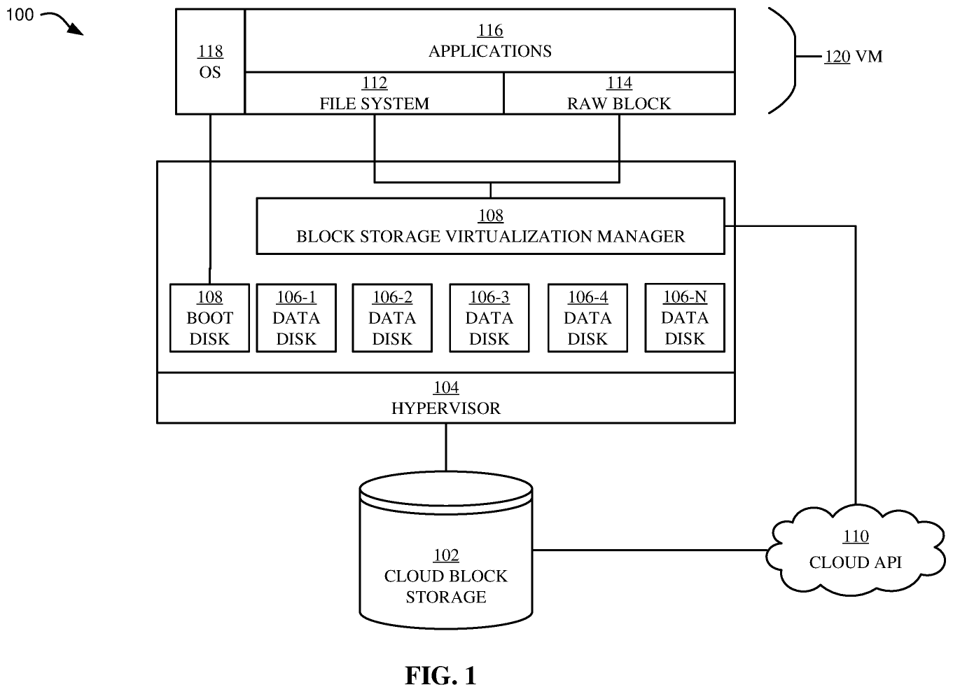

Referring now to FIG. 1, illustrated is a block diagram of an example computing environment 100, in accordance with some embodiments of the present disclosure. Computing environment 100 includes cloud block storage 102 which includes block storage aggregated from one or more sources and provides the aggregated storage functionality to hypervisor 104. Hypervisor 104 (also referred to as a virtual machine monitor) can include any combination of one or more of hardware, firmware, and/or software configured to create and operate one or more VMs.

Cloud block storage 102 can be provisioned as various boot disks, storage disks, data disks, or other storage volumes via hypervisor 104. For example, cloud block storage 102 can be provisioned as data disks 106-1 through 106-N, where N can be any variable according to the particular configuration of the computing environment 100. Cloud block storage 102 can be further provisioned as a boot disk 108. In some embodiments, boot disk 108 can be stored at address /dev/sda whereas data disks 106-1 through 106-N can be stored at the subsequent addresses /dev/sd{b . . . N}. Boot disk 108 can be configured to support the OS 118 of a VM 120 (also referred to as a guest machine or client machine). In FIG. 1, a VM 120 can include one or more of, for example, OS 118, application 116, file system 112, and/or raw block 114 storage resources.

Computing environment 100 can further include a block storage virtualization (BSV) manager 108 that is associated with the computing environment 100. The BSV manager 108 can interact with cloud block storage 102 for strategically procuring and/or releasing storage resources for use by a VM. In some embodiments, the BSV manager 108 interacts with the cloud block storage 102 using a cloud Application Programming Interface (API) 110. BSV manager 108 can be configured to perform numerous functions including, but not limited to:
(i) Aggregate multiple cloud block devices of a VM 120 into one or several space efficient virtual volumes. For example, the BSV manager 108 can generate a virtual address space (e.g., /dev/sbsva) for aggregated physical address spaces (e.g., /dev/sda) where the virtual address space has configurable storage capacity and storage parameters;
(ii) Apply storage protocols to the storage volumes in the virtual address space (e.g., tiering, snapshots, redundant array of independent disks (RAID), flash copy, asynchronous or synchronous remote copy, data compression, data deduplication, etc.);
(iii) Provision additional storage resources to the computing environment 100 when the free space in the computing environment 100 falls below a provisioning threshold; and/or
(iv) Release storage resources from the computing environment 100 when the free space in the computing environment 100 exceeds a consolidation threshold.

BSV manager 108 can be configured to provide the aggregated storage resources (e.g., data disks 106-1 to 106-N) to one or more applications 116, where the one or more applications 116 can utilize the storage resources for file system 112 workloads and/or raw block 114 workloads.

In some embodiments, the BSV manager 108 is associated with the computing environment 100 as a kernel module or as a Network Block Device (NBD). When the BSV manager 108 is implemented as one or more kernel modules (e.g., a loadable kernel module (LKM)), the kernel module can take the form of an object file containing executable program code configured to extend a running kernel of an OS 118.

When the BSV manager 108 is implemented as a NBD, the NBD can be a device node with content provided by a remote machine. The NBD can include, for example, a server portion, a client portion, and a network connecting the server portion to the client portion. A kernel driver on the client portion can be configured to forward requests generated at the client portion to the server portion. In some embodiments, the server portion utilizes a userspace program to handle requests from the client portion via the network.

In various embodiments, the BSV manager 108 is associated with one or many VMs. In some embodiments, the BSV manager 108 is provisioned to a VM 120 from a remote data processing system.

FIG. 1 is shown for representative purposes and is not to be construed as limiting. For example, the BSV manager 108 can reside in various locations such as on top of the hypervisor 104, as a part of OS 118, or associated with application 116, file system 112, and/or raw block 114 components. Likewise, the other components of FIG. 1 can be organized in different arrangements than the arrangement shown in FIG. 1, if they exist at all.

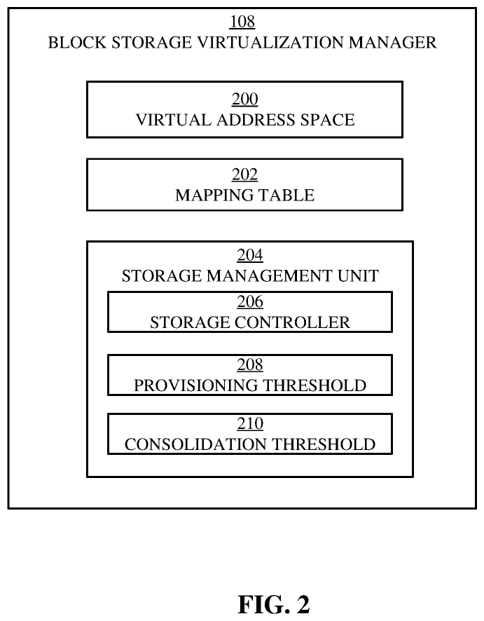

FIG. 2 illustrates a block diagram of an example BSV manager 108, in accordance with some embodiments of the present disclosure. BSV manager 108 can include a virtual address space 200 for aggregating virtually provisioned block storage resources of the computing environment 100. For example, the virtual address space 200 can create a virtual device at a path /dev/sbsv{N} rather than a traditional path such as /dev/sd{N}. The virtual address space 200 can be associated with a maximum capacity and an allocated capacity. The maximum capacity can refer to a configurable capacity of the virtual address space 200. The allocated capacity can refer to a configured, provisioned, or usable amount of the virtual address space 200. As a result, the allocated capacity is less than or equal to the maximum capacity. Further, the allocated capacity can be made up of free space and used space.

BSV manager 108 further includes a mapping table 202 for mapping the virtual address space 200 to a physical address space (e.g., a disk identifier and a logical block address (LBA)) of the aggregated block storage resources associated with the computing environment 100. In various embodiments, the mapping table 202 can allocate all physical disk space and fill the mapping table 202 at the beginning (e.g., when associating the BSV manager 108 with the computing environment 100) or the mapping table 202 can allocate physical disk space when an application 116 first utilizes the virtual address space 200. In some embodiments, the mapping table 202 allocates physical storage space on a first write of application 116 and returns zero on unallocated reads in the virtual address space 200. The mapping table 202 can be stored in a known area of data disks 106-1 to 106-N. For example, a last 1 gigabyte (GB) on each data disk 106-1 to 106-N can be used as a metadata area that stores the mapping table 202.

BSV manager 108 further includes a storage management unit 204 that can contain storage controller 206 for applying storage protocols to the block storage resources aggregated in the virtual address space 200 such as, but not limited to, a storage configuration (e.g., RAID, tiering, etc.), a storage backup protocol (e.g., snapshots, flash copy, asynchronous remote copy, synchronous remote copy, etc.), a data reduction technique (e.g., compression, deduplication, etc.), and so on. Here, storage controller 206 can refer to functionality capable of implementing protocols and procedures that may be implemented by a storage controller (rather than necessarily referring to a literal or physical storage controller).

The storage management unit 204 can further include a provisioning threshold 208 and a consolidation threshold 210. The provisioning threshold 208 can be used to trigger procurement of additional storage resources. For example, if the amount of free space associated with the BSV manager 108 is below the provisioning threshold 208, then the BSV manager 108 can procure additional storage resources.

Several non-limiting examples of provisioning threshold 208 are provided. As one example, the provisioning threshold 208 can be a percentage of free space remaining in the allocated capacity of the virtual address space 200. In such embodiments, the provisional threshold 208 can be any percentage less than 10% or within the inclusive range of 0.5% to 50%. As another example, the provisioning threshold 208 can be an amount of free space remaining in the virtual address space 200 such as any amount less than 100 megabytes (MB) or within the inclusive range of 10 MB to 10 terabytes (TB). As another example, the provisioning threshold 208 can be a number of unused storage volumes in the allocated capacity of the virtual address space 200, such as less than 1, 2, or a different number of unused storage volumes in the virtual address space 200.

The consolidation threshold 210 can be used to trigger release of storage resources. For example, if the amount of free space associated with the BSV manager 108 exceeds the consolidation threshold 210, then the BSV manager 108 can consolidate storage resources and release unused storage resources.

Several non-limiting examples of consolidation threshold 210 are provided. As one example, the consolidation threshold 210 can be a percentage of free space remaining in the allocated capacity of the virtual address space 200. In such embodiments, the consolidation threshold 210 can be any percentage greater than 10% or any percentage within the inclusive range of 1% to 50%. As another example, the consolidation threshold 210 can be an amount of free space remaining in the allocated capacity of the virtual address space 200. In such embodiments, the consolidation threshold 210 can be any amount greater than 100 MB or within an inclusive range of 10 MB to 10 TB. As another example, the consolidation threshold 210 can be a number of unused storage volumes in the allocated capacity of the virtual address space 200, such as more than 2, 3, 5 or a different number of unused storage volumes in the virtual address space 200.

Intermittently procuring additional storage resources as-needed (e.g., as triggered by the provisioning threshold 208) and incrementally releasing excess storage resources as-needed (e.g., as triggered by the consolidation threshold 210) is useful for efficiently maintaining an appropriate amount of storage space. Although not explicitly shown in FIG. 2, BSV manager 108 can store appropriate user credentials for authorizing procurement and/or release of various storage resources at various times without necessarily requiring manual input.

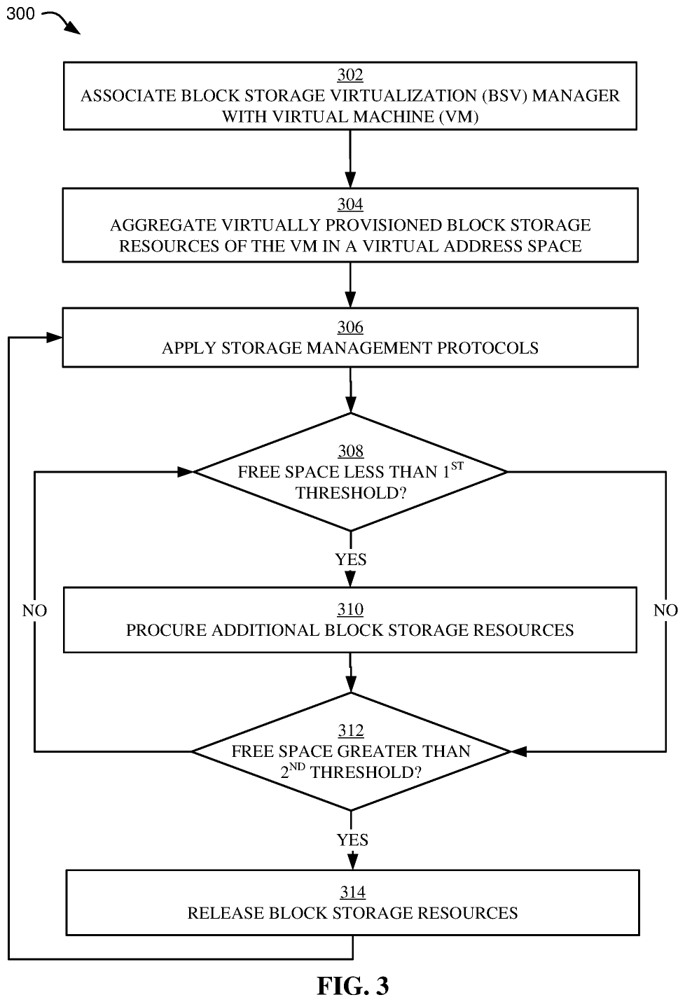

FIG. 3 illustrates a flowchart of an example method 300 for implementing a BSV manager 108 in a computing environment 100, in accordance with some embodiments of the present disclosure. In some embodiments, the method 300 can be implemented by a BSV manager 108 or a different configuration of hardware and/or software.

Operation 302 includes associating a BSV manager 108 with a VM 120 that has virtually provisioned block storage resources. Operation 302 can include, for example, connecting the BSV manager 108 to a VM 120 (e.g., OS 118, application 116, etc.), a hypervisor 104, and/or to a cloud block storage 102. In some embodiments, operation 302 includes installing the BSV manager 108 on the VM 120 from a remote data processing system.

Operation 304 includes aggregating virtually provisioned block storage resources of the VM 120 in a virtual address space 200. In some embodiments, operation 304 includes defining a maximum capacity (e.g., 1 petabyte (PB)) of the virtual address space 200 and an allocated capacity, where the allocated capacity is less than the maximum capacity. Here, the allocated capacity can refer to usable block storage resources (whether free or used) and the maximum capacity can refer to a maximum configurable size of the virtual address space 200 (even though the virtual address space 200 may not physically have storage resources immediately available up to the maximum capacity). In some embodiments, operation 304 further includes partitioning the available storage space into a certain extent size (e.g., 256 MB).

In some embodiments, operation 304 includes generating a mapping table 202 for mapping the virtual address space 200 to a physical address space. For example, the virtual address space 200 can be mapped to data disks 106-1 to 106-N. In some embodiments, the mapping table 202 is stored in a predetermined location of one or more data disks 106-1 to 106-N. For example, a last 1 GB section of each data disk 106-1 to 106-N can be reserved for metadata including the mapping table 202.

Operation 306 includes applying storage management protocols to the storage resources in the virtual address space 200. Storage management protocols can include, but are not limited to, storage configuration (e.g., RAID, tiering, etc.), storage backup (e.g., snapshots, flash copy, asynchronous remote copy, synchronous remote copy, etc.), data reduction (e.g., compression, deduplication, etc.), and so on.

Operation 308 includes determining if the free space associated with the BSV manager 108 (e.g., unused space in the allocated capacity of the virtual address space 200) is less than or equal to the provisioning threshold 208. Further, while not explicitly shown in operation 308, operation 308 can also include verifying that the allocated capacity is less than the maximum capacity. If so (308: YES), the method 300 proceeds to operation 310 and procures additional block storage resources. In some embodiments, operation 310 can use a cloud API 110 for interfacing with a vendor for procuring or releasing cloud block storage 102. The additional block storage resources procured in operation 310 can be added to the allocated capacity of the virtual address space 200.

The additional block storage resources can be procured in various amounts based on the configuration of the BSV manager 108. For example, the additional block storage can be procured in an inclusive range of 10 MB to one TB. As another example, the additional block storage can be procured within an inclusive range of 5% to 100% of a size of the allocated capacity in the virtual address space 200. As yet another example, the additional block storage can be procured within an inclusive range of 1% to 50% of the maximum capacity of the virtual address space 200.

Operation 310 can utilize information in an account (e.g., a user's account) for automatically procuring additional block storage resources. The account information can include parameters related to procuring additional block storage resources including, for example, an increment of storage to be added at each procurement (e.g., 1 GB, 1 TB, etc.), a maximum spend per time interval (e.g., less than $100 per month), or other parameters.

After operation 310, the method 300 proceeds to operation 312. Likewise, referring back to operation 308, if the free space associated with the BSV manager 108 is not less than or equal to the provisioning threshold 208 (308: NO), the method 300 proceeds to operation 312. Operation 312 includes determining if the amount of free space associated with the BSV manager 108 (e.g., unused space in the allocated capacity of the virtual address space 200) is greater than or equal to the consolidation threshold 210. If so (312: YES), the method 300 proceeds to operation 314.

Operation 314 includes releasing block storage resources. In some embodiments, operation 314 includes migrating data off one or more storage volumes and then releasing (e.g., deleting, removing, returning, etc.) the empty storage volumes. The amount of released block storage resources can be varying amounts based on the configuration of the BSV manager 108. For example, the amount of released block storage resources can be within an inclusive range of one to five storage volumes, within an inclusive range of 10 MB to one TB, within an inclusive range of 1% to 50% of the allocated capacity of the virtual address space, or a different amount.

In some embodiments, the method 300 returns to operation 306 and repeatedly cycles through one or more of operations 306-314 to intermittently procure additional storage resources and/or release unused storage resources. The aforementioned operations can be completed in any order and are not limited to those described. Additionally, some, all, or none of the aforementioned operations can be completed, while still remaining within the spirit and scope of the present disclosure.

One non-limiting example is provided to further clarify some aspects of the present disclosure. An application 116 is planned to utilize 1 TB of storage. Rather than purchasing 1 TB of storage initially, aspects of the present disclosure can be configured to allocate a VM 120 with a root volume of 100 GB and mounted at a location such as /dev/sda for a certain OS 118. A BSV manager 108 can be installed and allocate 100 GB of initial storage. The BSV manager 108 can create a virtual device at /dev/sbsva with a maximum storage capacity of 2 TB. Next, application 116 can create a file system 112 on /dev/sbsva and run a workload on it. In this example, an interval of time later (e.g., 1 week), the application 116 may have written 90 GB of data. In response, the BSV manager 108 can allocate another 100 GB of storage. Here, the fact that 90 GB used of 100 GB available may trigger a provisioning threshold 208 (e.g., where the provisioning threshold 208 can be 10% remaining free space, 10 GB free space, or another metric). Meanwhile, in the background, the storage controller 206 of the BSV manager 108 can be configured to rebalance storage between these two volumes to create software RAID 0 with doubled performance.

Continuing the above example, another interval of time later (e.g., another 1 week), the application 116 may have used 190 GB. In response, the BSV manager 108 can allocate another 100 GB in response to the triggering of the provisioning threshold 208. Further, the storage controller 206 can be configured to re-stripe across these three volumes to increase performance.

Continuing the above example, a half year later, the application 116 may have used 950 GB of space and the BSV manager 108 can have collectively allocated 1 TB of volume. At this point in the example, cost savings is realized insofar as 1 TB of volume is incrementally procured as-needed over the course of half a year rather than fully procured initially at the beginning of the year. In other words, during the first half of the year, as the storage requirements of application 116 are scaled, the BSV manager 108 enables incremental increases in block storage capacity.

Continuing the above example, the BSV manager 108 can determine that approximately 200 GB of data (e.g., files) have been deleted. This determination can trigger a consolidation threshold 210 (e.g., 10% unused space, 20% unused space, 100 GB unused space, 200 GB unused space, etc.). In response, the BSV manager 108 can be configured to migrate data off two 100 GB volumes and release them. At this point in the example, cost savings is realized insofar as unnecessary block storage capacity is released.

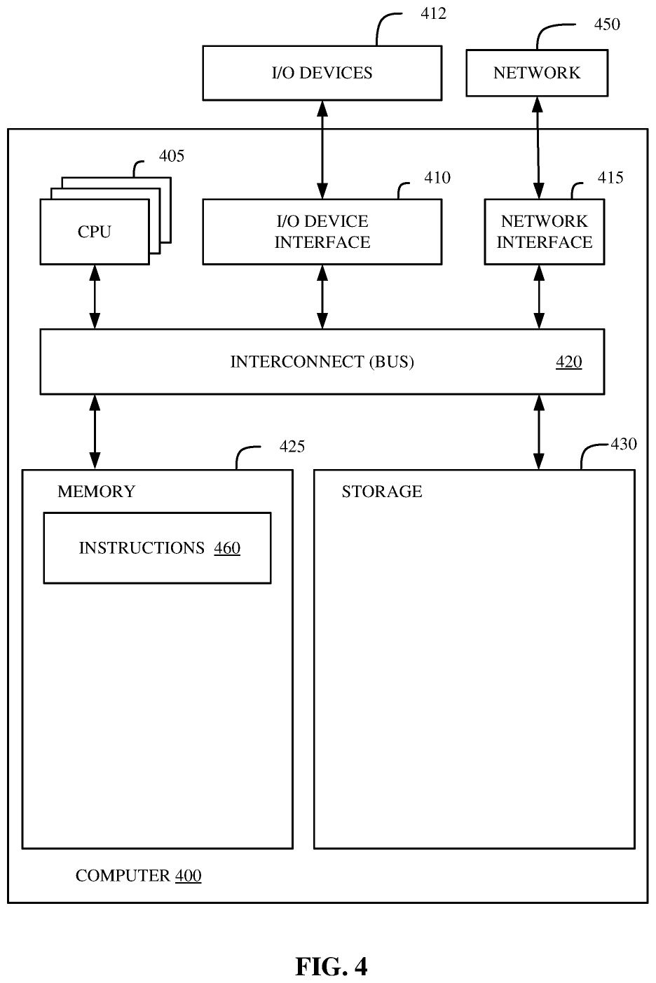

FIG. 4 illustrates a block diagram of an example computer 400 in accordance with some embodiments of the present disclosure. In various embodiments, computer 400 can perform the methods described in FIG. 3 and/or implement the functionality discussed in FIGS. 1 and 2. In some embodiments, computer 400 receives instructions related to the aforementioned methods and functionalities by downloading processor-executable instructions from a remote data processing system via network 450. In other embodiments, computer 400 provides instructions for the aforementioned methods and/or functionalities to a client machine such that the client machine executes the method, or a portion of the method, based on the instructions provided by computer 400. In some embodiments, the computer 400 is incorporated into BSV manager 108.

Computer 400 includes memory 425, storage 430, interconnect 420 (e.g., BUS), one or more CPUs 405 (also referred to as processors herein), I/O device interface 410, I/O devices 412, and network interface 415.

Each CPU 405 retrieves and executes programming instructions stored in memory 425 or storage 430. Interconnect 420 is used to move data, such as programming instructions, between the CPUs 405, I/O device interface 410, storage 430, network interface 415, and memory 425. Interconnect 420 can be implemented using one or more busses. CPUs 405 can be a single CPU, multiple CPUs, or a single CPU having multiple processing cores in various embodiments. In some embodiments, CPU 405 can be a digital signal processor (DSP). In some embodiments, CPU 405 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 425 is generally included to be representative of a random-access memory (e.g., static random-access memory (SRAM), dynamic random access memory (DRAM), or Flash). Storage 430 is generally included to be representative of a non-volatile memory, such as a hard disk drive, solid state device (SSD), removable memory cards, optical storage, or flash memory devices. In an alternative embodiment, storage 430 can be replaced by storage area-network (SAN) devices, the cloud, or other devices connected to computer 400 via I/O device interface 410 or network 450 via network interface 415.

In some embodiments, memory 425 stores instructions 460. However, in various embodiments, instructions 460 are stored partially in memory 425 and partially in storage 430, or they are stored entirely in memory 425 or entirely in storage 430, or they are accessed over network 450 via network interface 415.

Instructions 460 can be processor-executable instructions for performing any portion of, or all of, any of the methods of FIG. 3 and/or implementing any of the functionality discussed in FIG. 1 or 2.

In various embodiments, I/O devices 412 include an interface capable of presenting information and receiving input. For example, I/O devices 412 can present information to a user interacting with computer 400 and receive input from the user.

Computer 400 is connected to network 450 via network interface 415. Network 450 can comprise a physical, wireless, cellular, or different network.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

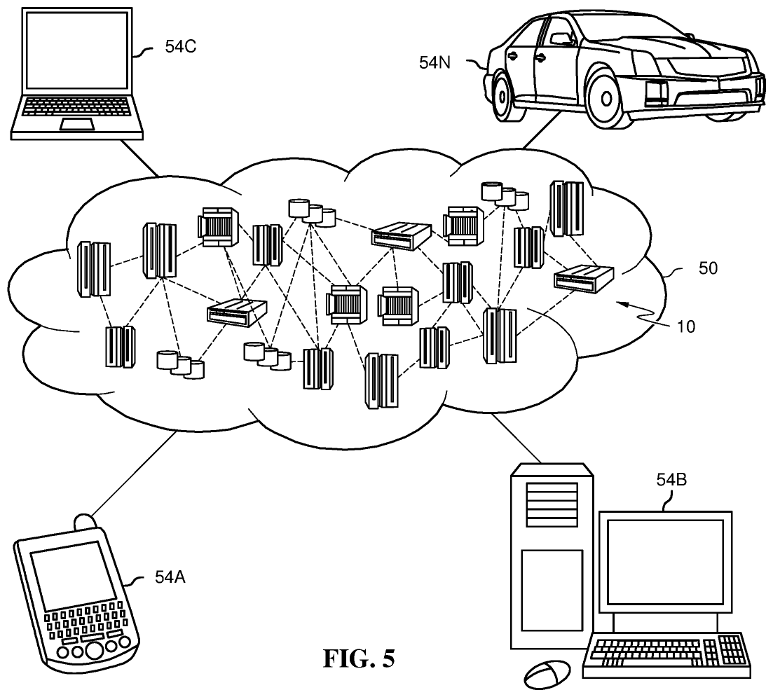

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

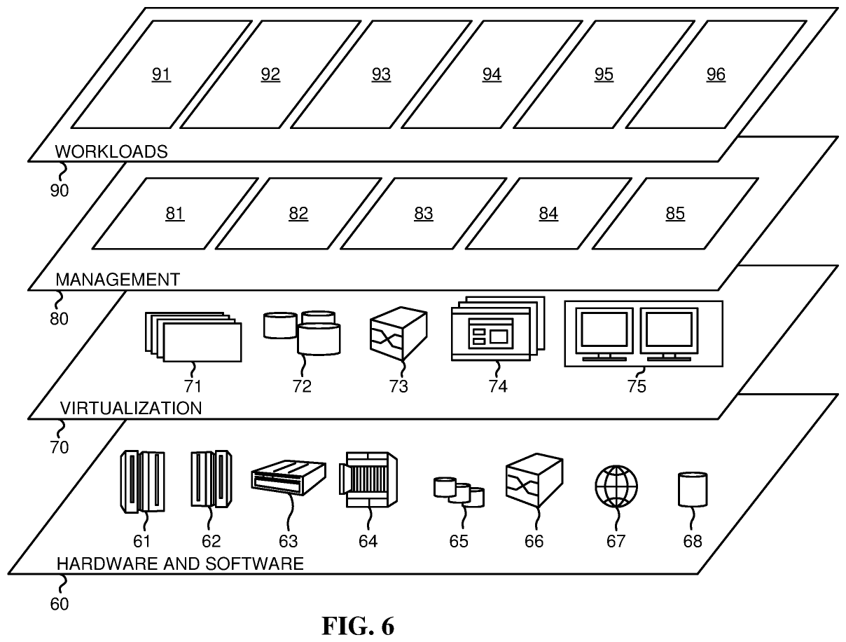

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and block storage virtualization management 96.

Embodiments of the present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any of the instructions stored in instructions 460 of FIG. 4 and/or any software configured to perform any subset of the methods described with respect to FIG. 3 and/or any of the functionality discussed in FIGS. 1 and 2) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

Several examples will now be provided to further clarify various aspects of the present disclosure.

Example 1: A method comprising associating a Block Storage Virtualization (BSV) manager with a virtual machine (VM) having virtually provisioned block storage resources. The method further comprises aggregating, by the BSV manager, the virtually provisioned block storage resources into a virtual address space having a maximum capacity and an allocated capacity, wherein the allocated capacity is less than the maximum capacity. The method further comprises determining, by the BSV manager, that free space in the allocated capacity is less than a provisioning threshold. The method further comprises, in response to determining that the free space in the allocated capacity is less than the provisioning threshold, procuring, by the BSV manager, a predetermined amount of additional block storage resources for the VM.

Example 2: The limitations of Example 1, wherein the method further comprises generating a mapping table for mapping addresses in the virtual address space to physical addresses in the virtually provisioned block storage resources.

Example 3: The limitations of any one of Examples 1-2, wherein the BSV manager repeatedly procures additional block storage resources at each time that: (1) the free space in the allocated capacity is less than the provisioning threshold; and (2) the allocated capacity is less than the maximum capacity.

Example 4: The limitations of any one of Examples 1-3, wherein the BSV manager procures additional block storage resources using an application programming interface (API) in communication with a virtual block storage vendor via a network.

Example 5: The limitations of any one of Examples 1-4, wherein the method further comprises detecting that free space in the allocated capacity is greater than a consolidation threshold; and in response to determining that the free space in the allocated capacity is greater than the consolidation threshold, releasing a second predetermined amount of block storage resources associated with the VM.

Example 6: The limitations of Example 5, wherein the second predetermined amount of block storage resources is within an inclusive range selected from a group consisting of: of one to five storage volumes; 10 megabytes (MB) to one terabyte (TB); and 1% to 50% of the allocated capacity.

Example 7: The limitations of Example 5, wherein the consolidation threshold is selected from a group consisting of: a percentage of free space in the allocated capacity that is greater than or equal to 10% of the allocated capacity; an amount of free space in the allocated capacity that is greater than or equal to 100 megabytes (MB); and greater than or equal to two volumes of free space in the allocated capacity.

Example 8: The limitations of any one of Examples 1-7, wherein the predetermined amount of additional block storage resources is in an inclusive range selected from a group consisting of: 10 megabytes (MB) to one terabyte (TB); 5% to 100% of a size of the allocated capacity; and 1% to 50% of the maximum capacity.

Example 9: The limitations of any one of Examples 1-7, wherein the provisioning threshold is selected from a group consisting of: a percentage of free space in the allocated capacity that is less than or equal to 10% of the allocated capacity; an amount of free space in the allocated capacity that is less than or equal to 100 megabytes (MB); and one volume of free space in the allocated capacity.

Example 10: The limitations of any one of Examples 1-9, wherein the BSV manager is a kernel module.

Example 11: The limitations of any one of Examples 1-9, wherein the BSV manager is a Network Block Device (NBD).

Example 12: The limitations of any one of Examples 1-11, wherein the BSV manager is installed at the VM from a remote data processing system.

Example 13: The limitations of any one of Examples 1-12, wherein the maximum capacity of the virtual address space is a configurable size of the virtual address space, wherein the allocated capacity of the virtual address space is a configured amount of the virtual address space, wherein the allocated capacity comprises free space and used space.

Example 14: A system comprising a processor and a computer-readable storage medium storing program instructions which, when executed by the processor, are configured to cause the processor to perform a method according to any one of Examples 1-13.

Example 15: A computer program product comprising a computer readable storage medium having program instructions embodied therewith, the program instructions executable by a processor to cause the processor to perform a method according to any one of Examples 1-13.

What is claimed is:

1. A method comprising:
associating a Block Storage Virtualization (BSV) manager with a virtual machine (VM) having virtually provisioned block storage resources;
aggregating, by the BSV manager, the virtually provisioned block storage resources into a virtual address space having a maximum capacity and an allocated capacity, wherein the allocated capacity is less than the maximum capacity;
determining, by the BSV manager, that free space in the allocated capacity is less than a provisioning threshold; and
in response to determining that the free space in the allocated capacity is less than the provisioning threshold, procuring, by the BSV manager, a predetermined amount of additional block storage resources for the VM.

2. The method of claim 1, further comprising:
generating a mapping table for mapping addresses in the virtual address space to physical addresses in the virtually provisioned block storage resources.

3. The method of claim 1, wherein the BSV manager repeatedly procures additional block storage resources at each time that:
the free space in the allocated capacity is less than the provisioning threshold; and
the allocated capacity is less than the maximum capacity.

4. The method of claim 3, wherein the BSV manager procures the additional block storage resources using an application programming interface (API) in communication with a virtual block storage vendor via a network.

5. The method of claim 1, further comprising:
detecting that free space in the allocated capacity is greater than a consolidation threshold; and
in response to determining that the free space in the allocated capacity is greater than the consolidation threshold, releasing a second predetermined amount of block storage resources associated with the VM.

6. The method of claim 5, wherein the second predetermined amount of block storage resources is within an inclusive range selected from a group consisting of:
one to five storage volumes;
10 megabytes (MB) to one terabyte (TB); and
1% to 50% of the allocated capacity.

7. The method of claim 5, wherein the consolidation threshold is selected from a group consisting of:
a percentage of free space in the allocated capacity that is greater than or equal to 10% of the allocated capacity;
an amount of free space in the allocated capacity that is greater than or equal to 100 megabytes (MB); and
greater than or equal to two volumes of free space in the allocated capacity.

8. The method of claim 1, wherein the predetermined amount of additional block storage resources is in an inclusive range selected from a group consisting of:
10 megabytes (MB) to one terabyte (TB);
5% to 100% of a size of the allocated capacity; and
1% to 50% of the maximum capacity.

9. The method of claim 1, wherein the provisioning threshold is selected from a group consisting of:
a percentage of free space in the allocated capacity that is less than or equal to 10% of the allocated capacity;
an amount of free space in the allocated capacity that is less than or equal to 100 megabytes (MB); and
one volume of free space in the allocated capacity.

10. The method of claim 1, wherein the BSV manager is a kernel module.

11. The method of claim 1, wherein the BSV manager is a Network Block Device (NBD).

12. The method of claim 1, wherein the BSV manager is installed at the VM from a remote data processing system.

13. A system comprising:
a processor; and
a computer-readable storage medium storing program instructions which, when executed by the processor, are configured to cause the processor to perform a method comprising:
associating a Block Storage Virtualization (BSV) manager with a virtual machine (VM) having virtually provisioned block storage resources;
aggregating, by the BSV manager, the virtually provisioned block storage resources into a virtual address space having a maximum capacity and an allocated capacity, wherein the allocated capacity is less than the maximum capacity;
determining, by the BSV manager, that free space in the allocated capacity is less than a provisioning threshold; and
in response to determining that the free space in the allocated capacity is less than the provisioning threshold, procuring, by the BSV manager, a predetermined amount of additional block storage resources for the VM.

14. The system of claim 13, the method further comprising:
generating a mapping table for mapping addresses in the virtual address space to physical addresses in the virtually provisioned block storage resources.

15. The system of claim 13, wherein the BSV manager repeatedly procures additional block storage resources at each time that:
the free space in the allocated capacity is less than the provisioning threshold; and
the allocated capacity is less than the maximum capacity.

16. The system of claim 13, the method further comprising:
detecting that free space in the allocated capacity is greater than a consolidation threshold; and
in response to determining that the free space in the allocated capacity is greater than the consolidation threshold, releasing a second predetermined amount of block storage resources associated with the VM.

17. The system of claim 16, wherein the maximum capacity of the virtual address space is a configurable size of the virtual address space, wherein the allocated capacity of the virtual address space is a configured amount of the virtual address space, wherein the allocated capacity comprises free space and used space.

18. The system of claim 13, wherein the BSV manager is a kernel module.

19. The system of claim 13, wherein the BSV manager is a Network Block Device (NBD).

20. A computer program product comprising a computer readable storage medium having program instructions embodied therewith, the program instructions executable by a processor to cause the processor to perform a method comprising:
associating a Block Storage Virtualization (BSV) manager with a virtual machine (VM) having virtually provisioned block storage resources;
aggregating, by BSV manager, the virtually provisioned block storage resources into a virtual address space having a maximum capacity and an allocated capacity, wherein the allocated capacity less than the maximum capacity;
determining, by the BSV manager, that free space in the allocated capacity is less than a provisioning threshold; and
in response to determining that the free space in the allocated capacity is less than the provisioning threshold, procuring, by the BSV manager, a predetermined amount of additional block storage resources for the VM.
